(19) United States
(12) Patent Application Publication
(10) Pub. No.: US 2011/0139758 A1
(43) Pub. Date: Jun. 16, 2011

(54) LATITUDINAL ISO-LINE SCRIBE, STITCHING, AND SIMPLIFIED LASER AND SCANNER CONTROLS

(75) Inventors: Jiafa Fan, San Jose, CA (US); Antoine P. Manens, Sunnyvale, CA (US)

(73) Assignee: Applied Materials, Inc., Santa Clara, CA (US)

(21) Appl. No.: 12/851,456

(22) Filed: Aug. 5, 2010

Related U.S. Application Data
(60) Provisional application No. 61/231,971, filed on Aug. 6, 2009.

(51) Int. Cl. B23K 26/00

(52) U.S. Cl. 219/121.72; 219/121.67

(57) ABSTRACT

The stitch points of segments formed into a workpiece by laser scribing can be improved by controlling aspects such as the velocity of the scanner and the switching points of the laser, such as to allow for lead-in, lead-out, and overlap periods. The locations of the stitch points also can be selected to coincide with existing lines such that the existing lines will function to connect the segments in the event of an offset.

### CROSS-REFERENCES TO RELATED APPLICATIONS

This application claims the benefit of U.S. Prov. Patent Application No. 61/231,971 filed Aug. 6, 2009, and titled “LATITUDINAL ISO-LINE SCRIBE, STITCHING, AND SIMPLIFIED LASER AND SCANNER CONTROLS” and incorporated herein by reference for all purposes.

### BACKGROUND OF THE INVENTION

Many embodiments described herein relate generally to the scribing of materials, as well as systems and methods for scribing materials. These systems and methods can be particularly effective in scribing single junction solar cells and thin-film multi junction solar cells.

Current methods for forming thin-film solar cells involve depositing or otherwise forming a plurality of layers on a substrate, for example, a glass, metal or polymer substrate suitable to form one or more p-n junctions. An example of a solar cell has an oxide layer (e.g., a transparent conductive oxide (TCO)) deposited on a substrate, followed by an amorphous-silicon layer and a metal-back layer. Examples of materials that can be used to form solar cells, along with methods and apparatus for forming the cells, are described, for example, in U.S. Pat. No. 7,582,515, issued Sep. 1, 2009, entitled “MULTI-JUNCTION SOLAR CELLS AND METHODS AND APPARATUSES FOR FORMING THE SAME,” which is hereby incorporated herein by reference. When a panel is being formed from a large substrate, a series of scribe lines is typically used within each layer to delineate the individual cells. The scribe lines are formed by laser ablating material from a workpiece, which consists of a substrate having at least one layer deposited thereon. The laser-scribing process may occur with the workpiece sitting supported on top of a planar stage or bed.

Laser-scribed patterns are formed on the workpiece by having relative motion between the laser beam and the workpiece. In previous approaches, this is accomplished by having the laser beam fixed and moving the workpiece. If the workpiece is held stationary on the stage or bed, then this would involve moving the stage or bed. If the workpiece has some degree of freedom to move on the stage or bed, then this would involve some combination of moving the workpiece and/or moving the stage or bed. Also, if the workpiece moves relative to a fixed laser then the bed might have to be up to four times the size of the workpiece, or the workpiece must be rotated, in order to access all areas of the workpiece. Further, under this fixed laser beam approach, the beam path from the scribing laser to the workpiece can be long. This long fixed beam path between the laser and the workpiece raises beam convergence and stability issues. Further, the stage or bed can consists of a single planar piece that holds the workpiece stationary and moves together with the workpiece. In order to accommodate the workpieces, which in one example can be as large as one square meter, this stage also has to be large, making it difficult to ship from the manufacturer site to the user site.

Furthermore, when using two or more lasers to scribe a pattern, complications arise. Limited scan field of the lasers implies a need for stitching. A conventional technique to obtain a constant velocity scribe uses lead-in and lead-out process, which involves complicated scanner and laser controls and lower throughput.

Accordingly, it is desirable to develop systems and methods that overcome at least some of these, as well as potentially other, deficiencies in existing scribing and solar panel manufacturing devices.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Systems and methods for improved stitching while laser scribing are provided. Many embodiments may provide for improved control, as well as the ability to scribe in multiple directions and/or patterns without rotating the workpiece. Systems and methods in accordance with many embodiments provide for general purpose, high-throughput, direct patterning laser scribing on large film-deposited substrates. These systems and methods may be particularly effective in scribing single junction solar cells and thin-film multi junction solar cells.

In many embodiments, a system for improved stitching while scribing a workpiece is provided. The system comprises at least one laser operable to generate output able to remove material from at least a portion of the workpiece and at least one scanner operable to direct output from the at least one laser to form first and second scribe segments, wherein at least one of a velocity of the scanner, a switching of the laser, and a patterning of the scribe segments is selected such that the first scribe at least partially overlaps with the second scribe on the workpiece. Alternatively a third scribe segment can be used in the stitching process; the process involves selecting a stitch point of the first and second scribe segments to substantially correspond to a position of a third scribe segment, such that the third scribe segment will function to connect the first and second scribe segments upon an offset of the first and second scribe segments on the workpiece.

In many embodiments, a method for improved stitching while scribing a workpiece is provided. The method comprises generating a first scribe on the workpiece; generating a second scribe on the workpiece; and controlling at least one of a velocity of at least one scanner used to direct at least one laser beam to form the first and second scribes, a switching of at least one laser used to form the first and second scribes, and patterning of the scribe segments such that the first scribe at least partially overlaps with the second scribe on the workpiece. Alternatively a third scribe segment can be used in the stitching process; the process involves selecting a stitch point of the first and second scribe segments to substantially correspond to a position of a third scribe segment, such that the third scribe segment will function to connect the first and second scribe segments upon an offset of the first and second scribe segments on the workpiece.

### BRIEF DESCRIPTION OF THE DRAWINGS

A further understanding of the nature and advantages of the invention may be realized by reference to the remaining portions of the specification and the drawings, wherein like reference numerals are used throughout the several drawings to refer to similar components. The Figures are incorporated into the detailed description portion of the invention.

FIG. 1 illustrates laser-scribed lines in a thin-film solar-cell assembly.

FIG. 2 illustrates a perspective view of a laser-scribing system in accordance with many embodiments.

FIG. 3 illustrates a side view of a laser-scribing system in accordance with many embodiments.

FIG. 4 illustrates an end view of a laser-scribing system in accordance with many embodiments.

FIG. 5 illustrates a top view of a laser-scribing system in accordance with many embodiments.

FIG. 6 illustrates a set of laser assemblies in accordance with many embodiments.

FIG. 7 illustrates components of a laser assembly in accordance with many embodiments.

FIG. 8A illustrates a method for scribing parallel to the movement direction of a workpiece in accordance with many embodiments.

FIG. 8B illustrates another method for scribing parallel to the movement direction of a workpiece in accordance with many embodiments.

FIG. 9A illustrates a method for scribing perpendicular to the movement direction of a workpiece in accordance with many embodiments.

FIG. 9B illustrates another method for scribing perpendicular to the movement direction of a workpiece in accordance with many embodiments.

FIGS. 10A and 10B illustrate a longitudinal and a latitudinal scan technique, respectively, that can be used in accordance with many embodiments.

FIGS. 11A-11C illustrate approaches for scribing lateral lines on a workpiece that can be used in accordance with many embodiments.

FIGS. 12A illustrates a scribe process by two vectors only, 12B shows a resultant sample.

FIG. 13 illustrates scribing with lead-in and lead-out.

FIG. 14A illustrates a scribing with an overlap, 14B shows a resultant sample.

FIG. 15 (A-C) illustrates stitching of different types of scribe patterns.

### DETAILED DESCRIPTION OF THE INVENTION

Systems and methods in accordance with many embodiments of the present disclosure can overcome one or more of the aforementioned and other deficiencies in existing scribing approaches. Many embodiments can provide for improved control as well as the ability to scribe in multiple directions and/or patterns without rotating a substrate. Systems and methods in accordance with many embodiments provide for general purpose, high-throughput, direct patterning laser scribing on large film-deposited substrates. Such systems and methods allow for bi-directional scribing, patterned scribing, arbitrary pattern scribing, and/or adjustable pitch scribing, without having to rotate a workpiece.

Systems and methods in accordance with many embodiments provide for laser scribing using simple longitudinal glass movement and multiple laser scanners to scribe workpieces, for example, film-deposited substrates used in some solar cell devices. The workpiece can be moved during scribing, and lasers direct beams to translatable scanners that direct the beams up through the substrate to the film(s) being scribed. The scanners can provide for both latitudinal and longitudinal scribing.

Many embodiments can provide for a relatively beam path from the scribing laser to the workpiece, which may significantly alleviate any beam convergence and stability issues. In many embodiments, a shorter beam path from the scribing laser to the workpiece is realized by having the laser source close to the workpiece. In many embodiments, this beam path is made even shorter by having the laser source move laterally according to the pattern the laser is trying to scribe. Allowing the laser source to be close to the workpiece allows the laser beam path to be minimized, which may help to minimize issues such as beam convergence and stability. In many embodiments, the workpiece moves longitudinally and the laser beam is able to move both laterally and longitudinally via a scanning device, but the laser beam path is still minimized as the laser source moves using a translation mechanism able to laterally translate the laser assemblies relative to the workpiece.

In many embodiments, a translation stage or bed is implemented with separated sections, such as substantially planar sections. In many embodiments, the center section is laterally movable, allowing the center section of the bed to move in conjunction with the laser source and optics as laterally translated by the translation mechanism, allowing a desired pattern to be scribed on the workpiece, while the two end sections of the bed are kept stationary. Such coordinated motion also provides various other advantages as described elsewhere herein. In many embodiments, the translation stage or bed consists of three or more sections that allow the base of the bed to be shipped in three or more parts using different packaging levels and assembled on site, making it easier to ship from the manufacturer site to the user site.

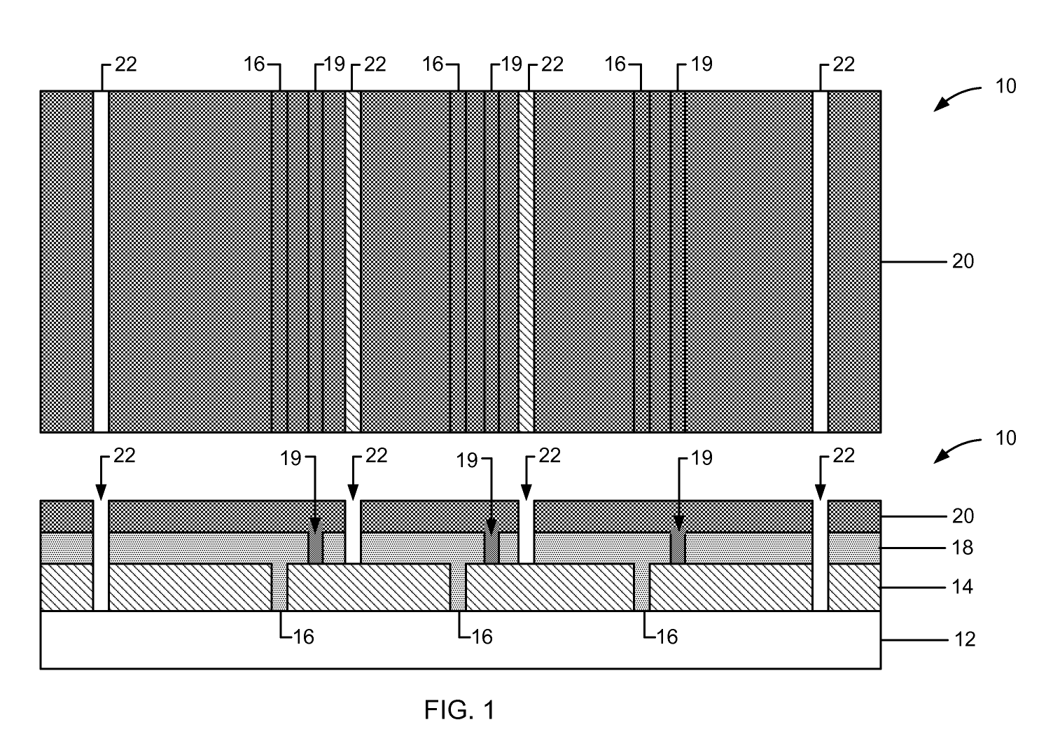

When a solar panel is being formed from a large substrate, for example, a series of laser-scribed lines can be used within each layer to delineate the individual cells. FIG. 1 illustrates laser-scribed lines within an example assembly 10 used in a thin-film solar cell. During the formation of the assembly 10, a glass substrate 12 has a transparent conductive oxide (TCO) layer 14 deposited thereon. The TCO layer 14 is then separated into isolated regions via laser-scribed P1 lines 16. Next, an amorphous-silicon (a-Si) layer 18 is deposited on top of the TCO layer 14 and within the scribed P1 lines 16. A second set of lines (“P2” lines 19) are then laser scribed in the amorphous-silicon (a-Si) layer 18. A metal-back layer 20 is then deposited on top of the amorphous-silicon (a-Si) layer 18 and within the scribed P2 lines 19. A third set of lines 22 (“P3” lines) are laser scribed as shown. While much of the area of the resultant assembly constitutes active regions of solar cells of the panel, various regions lying between the P1 16 and P3 22 scribe lines constitute non-active solar-cell area, also known as “the dead zone”.

In order to optimize the efficiency of these solar cell panels, the non-active solar cell area (i.e., the “dead zone”) of these panels should be minimized. To minimize the dead zone, each P3 line 22 should be aligned as close as possible to a corresponding P1 line 16. As will be discussed in more detail below, line sensing optics can be used to adjust the scribing of lines to minimize the dead zone area on the assembly 10.

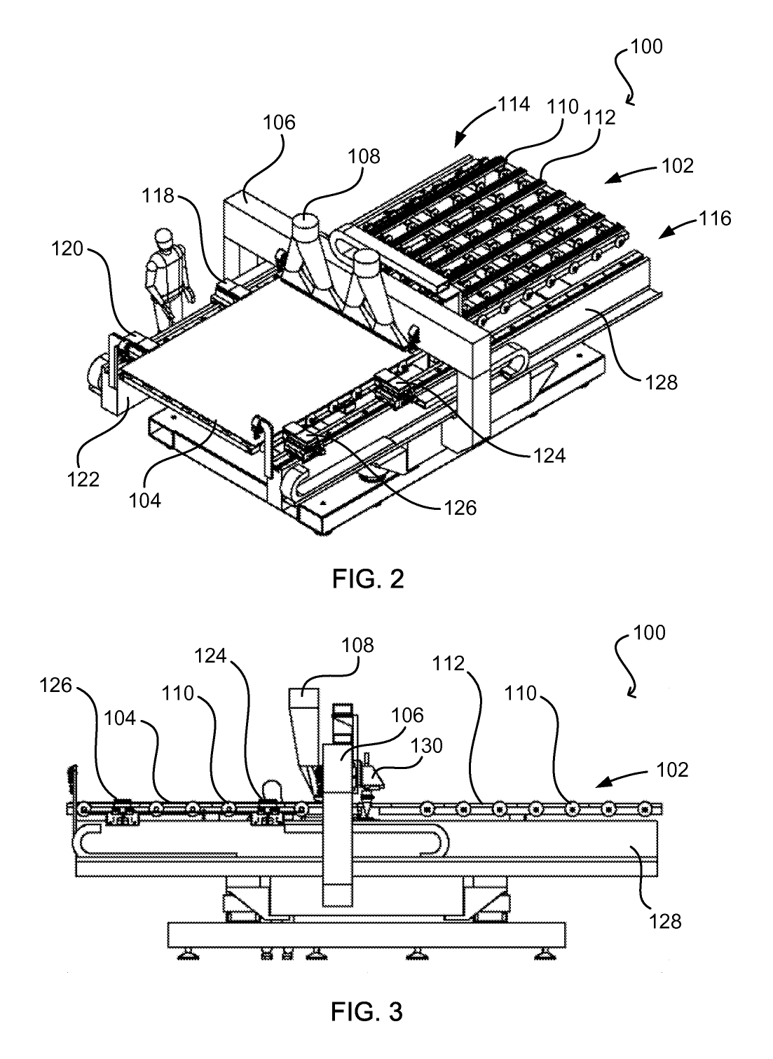

FIG. 2 illustrates an example of a laser-scribing system 100 in accordance with many embodiments. The system includes a translation stage or bed 102, as described herein, which may be leveled, for receiving and maneuvering a workpiece 104, for example, a substrate having at least one layer deposited thereon. In one example, the workpiece 104 is able to move along a single directional vector (i.e., for a Y-stage) at various rates (e.g., from 0 m/s to 2 m/s or faster). In many embodiments, the workpiece will be aligned to a fixed orientation with the long axis of the workpiece substantially parallel to the motion of the workpiece in the device, for reasons described elsewhere herein. The alignment can be aided by the use of cameras or imaging devices that acquire marks on the workpiece. In this example, the lasers and optics (shown in subsequent figures) are positioned beneath the workpiece and opposite a bridge 106 holding part of an exhaust mechanism 108 for extracting material ablated or otherwise removed from the substrate during the scribing process. The workpiece 104 can be loaded onto a first end of the stage 102 with the substrate side down (towards the lasers) and the layered side up (towards the exhaust). The workpiece is initially received onto an array of rollers 110 and can then be supported by a plurality of parallel air bearings 112 for supporting and allowing translation of the workpiece, although other bearing- or translation-type objects can be used to receive and translate the workpiece as known in the art. In this example, the array of rollers all point in a single direction, along the direction of propagation of the substrate, such that the workpiece 104 can be moved back and forth in a longitudinal direction relative to the laser assembly.

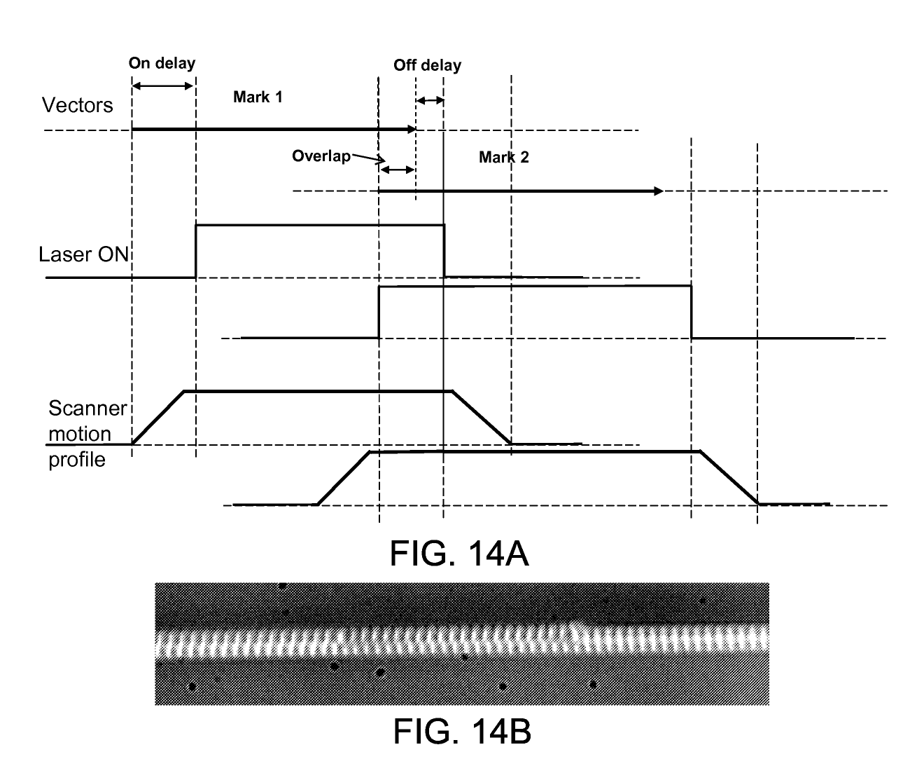

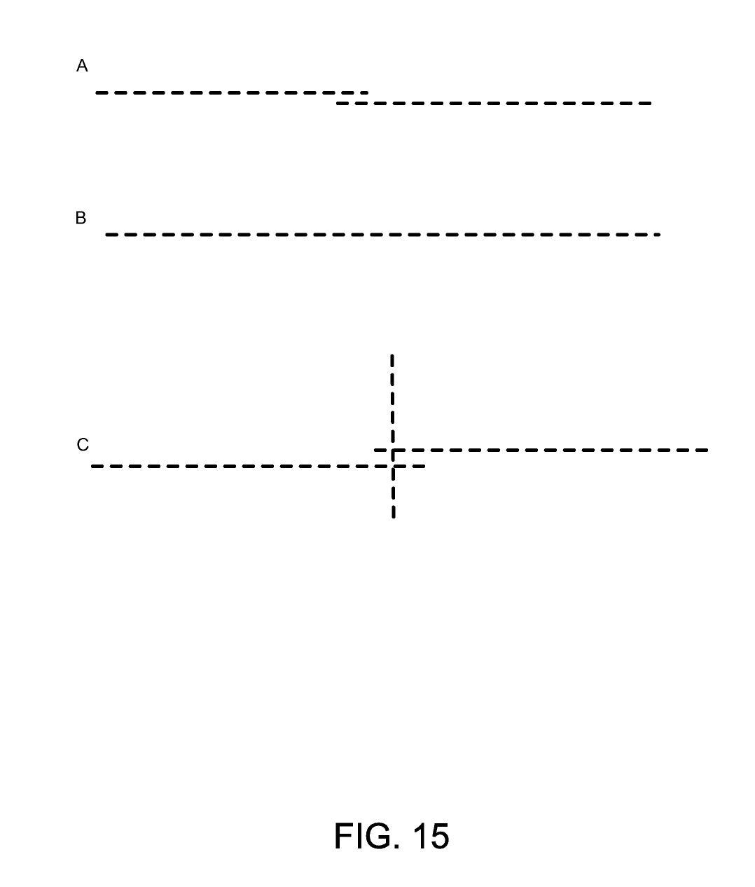

The system 100 includes a controllable drive mechanism for controlling a direction and translation velocity of the workpiece 104 on the stage 102. The controllable drive mechanism includes two Y-direction stages, a stage Y1 114 and stage Y2 116, disposed on opposite sides of the workpiece 104. The stage Y1 114 includes two X-direction stages (stage XA1 118 and stage XA2 120) and a Y1-stage support 122. The stage Y2 116 includes two X-direction stages (stage XB1 124 and stage XB2 126) and a Y2-stage support 128. The four X-direction stages 118, 120, 124, 126 include workpiece grippers for holding the workpiece 104. Each of the Y-direction stages 114, 116 include one or more air bearings, a linear motor, and a position sensing system. As will be described in more detail below with reference to FIGS. 14 and 15, the X-direction stages 118, 120, 124, 126 provide for more accurate workpiece movement by correcting for straightness variations that exist in the Y-direction stage supports 122, 128. The stage 102, bridge 106, and the Y-stage supports 122, 128, can be made out of at least one appropriate material, for example, the Y-stage supports 122, 128 of granite.

The movement of the workpiece 104 is also illustrated in the side view of the system 100 shown in FIG. 3, where the workpiece 104 moves back and forth along a vector that lies in the plane of the figure. Reference numbers are carried over between figures for somewhat similar elements for purposes of simplicity and explanation, but it should be understood that this should not be interpreted as a limitation on the various embodiments. As the workpiece is translated back and forth on the stage 102 by the Y-direction stages, a scribing area of the laser assembly effectively scribes from near an edge region of the substrate to near an opposite edge region of the substrate. The translation of the workpiece is facilitated in part by the movement of the stage Y2 (i.e., by the movement of X-direction stages 124, 126 along the Y2-stage support 128).

In order to ensure that the scribe lines are being formed properly, additional devices can be used. For example, an imaging device can image at least one of the lines after scribing. Further, a beam profiling device 130 can be used to calibrate the beams between processing of substrates or at other appropriate times. In many embodiments where scanners are used, for example, which may drift over time, a beam profiler allows for calibration of the beam and/or adjustment of a beam position.

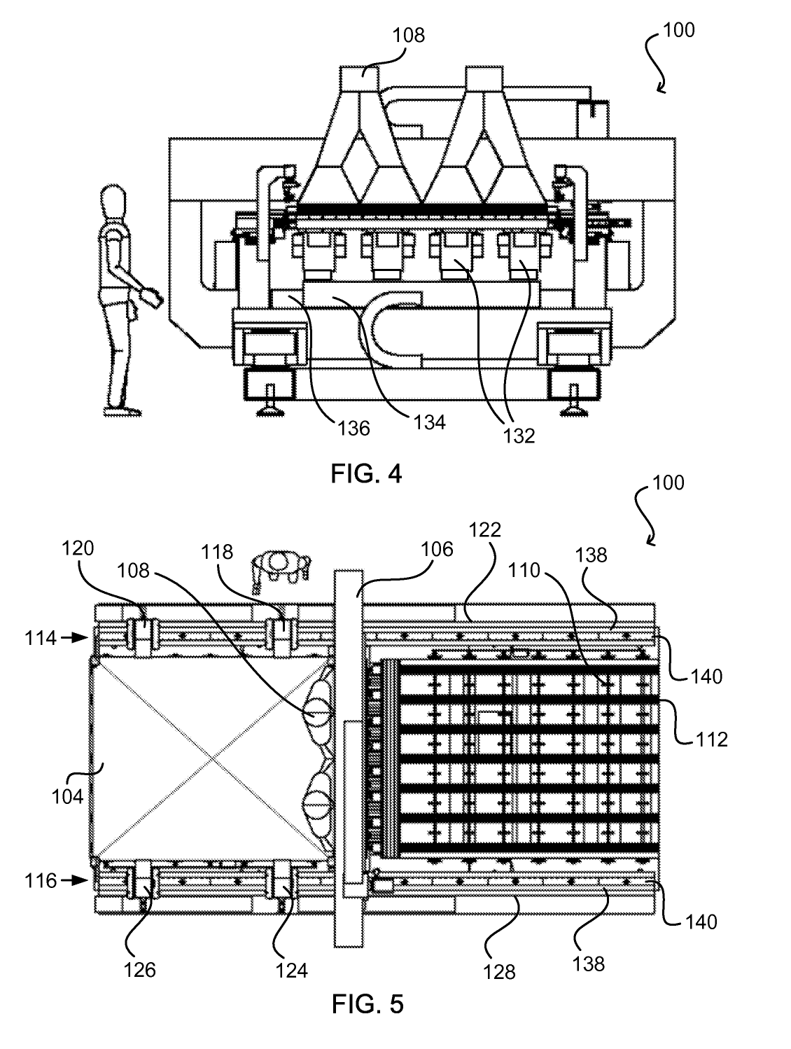

FIG. 4 illustrates an end view of the system 100, illustrating a series of laser assemblies 132 used to scribe the layers of the workpiece. While any number of laser assemblies 132 can be employed, in this specific example, there are four laser assemblies 132. Each of the laser assemblies 132 can include a laser device and elements, for example, lenses and other optical elements, needed to focus or otherwise adjust aspects of the laser. The laser device can be any appropriate laser device operable to ablate or otherwise scribe at least one layer of the workpiece, for example, a pulsed solid-state laser. As can be seen, a portion of the exhaust 108 is positioned opposite each laser assembly relative to the workpiece, in order to effectively exhaust material that is ablated or otherwise removed from the workpiece via the respective laser device. In many embodiments, the system is a split-axis system, where the stage 102 translates the workpiece 104 along a longitudinal axis (e.g., right to left in FIG. 3). The lasers and optics can be attached to a translation mechanism able to laterally translate the laser assemblies 132 relative to the workpiece 104 (e.g., right to left in FIG. 4). For example, the laser assemblies can be mounted on a support or platform 134 that is able to translate on a lateral rail 136, or using another translation mechanism, for example, a translation mechanism that may be driven by a controller and servo motor. In one system, the lasers and laser optics all move together laterally on the support 134 along with the center portion of the bed and the exhaust. This allows shifting scan areas laterally, while maintaining a small beam path and keeping the exhaust directly above the portions of the workpiece being ablated by the lasers. In some embodiments, the lasers, optics, center stage portion, and exhaust are all moved together by a single arm, platform, or other mechanism. In other embodiments, different components translate at least some of these components, with the movement being coordinates by a controller for example, as described in U.S. Patent Pub. No. 2009/0321397 A1, which has been previously incorporated herein by reference (via an above statement).

FIG. 5 illustrates a top view of the system 100 showing components of the Y-direction stages 114, 116. The Y-direction stage Y1 114 includes an X-direction stages XA1 118 and XA2 120, which translate along the Y1-stage support 122. The Y-direction stage Y2 116 includes an X-direction stages XB1 124 and XB2 126, which translate along the Y2-stage support 128. Each of the Y-direction stages 114, 116 includes a linear motor having a magnetic channel 138 disposed within the top portion of Y-direction stage supports 122, 128. Each of the Y-direction stages 114, 116 also includes a position sensing system, which includes an encoder strip 140 disposed on the respective Y-direction stage support 122, 128. Each of the Y-direction stages 114, 116 includes a reader head for monitoring the position of the Y-direction stage via reading the respective encoder strip 140.

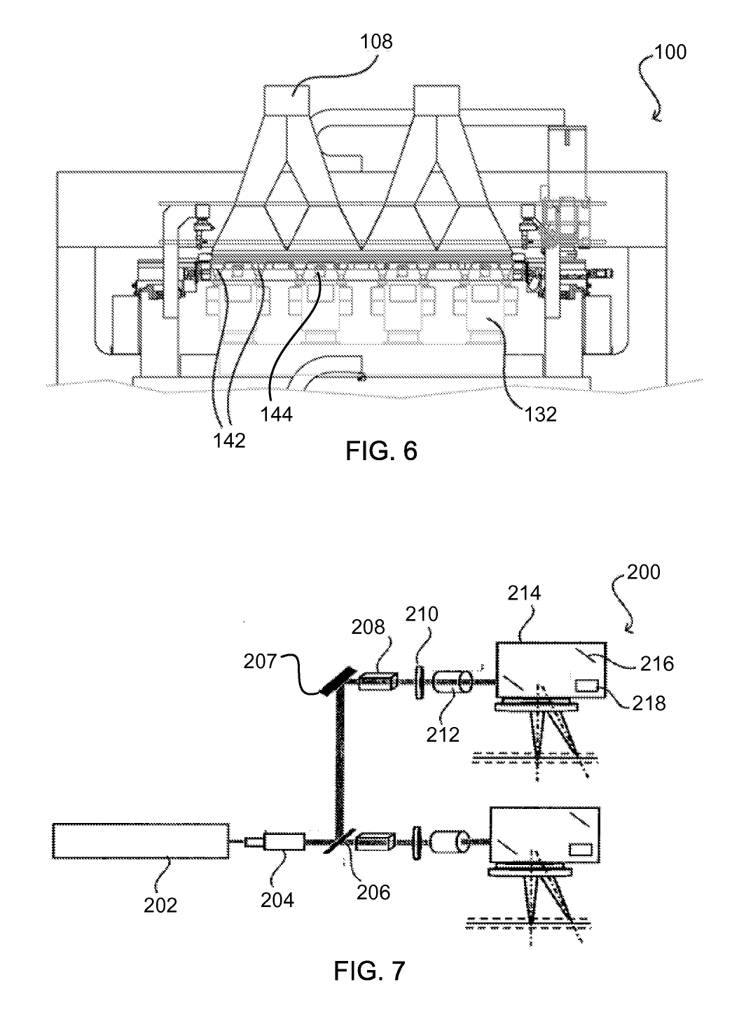

FIG. 6 is a focused view of the system 100 showing that each laser device of the system 100 actually produces two effective beams 142 useful for scribing the workpiece. In other embodiments, each laser device can be used to produce any number of effective beams, for example, two, three, or more effective beams. In order to provide the pair of beams, each laser assembly 132 includes at least one beam splitting device. As can be seen, each portion of the exhaust 108 covers a scan field, or an active area, of the pair of beams in this example, although the exhaust could be further broken down to have a separate portion for the scan field of each individual beam. Each beam in this example passes between air bearings of the bed, and the beam position between the air bearings is retained during lateral translation of the moveable center section, lasers, and optics.

Substrate thickness sensors 144 provide data that can be used to adjust heights in the system to maintain proper separation from the substrate due to variations between substrates and/or in a single substrate. For example, each laser can be adjustable in height (e.g., along the z-axis) using a z-stage, motor, and controller, for example. In many embodiments, the system is able to handle 3-5 mm differences in substrate thickness, although many other such adjustments are possible. The z-motors also can be used to adjust the focus of each laser on the substrate by adjusting the vertical position of the laser itself. A desired vertical focus of each laser can be used to selectively ablate one or more layers of the workpiece by concentrating the beam at the desired vertical position or range of vertical positions so as to produce the desired ablation. By adjusting the focus of each laser to local variations of the workpiece, more consistent line widths and spot shapes can be achieved.

FIG. 7 diagrammatically illustrates basic elements of an exemplary laser assembly 200 that can be used in accordance with many embodiments, although it should be understood that additional or other elements can be used as appropriate. In assembly 200, a single laser device 202 generates a beam that is expanded using a beam expander 204 then passed to a beam splitter 206, for example, a partially transmissive mirror, half-silvered mirror, prism assembly, etc., to form first and second beam portions. One or more of the beam portions can be redirected by a mirror 207. In this assembly, each beam portion passes through an attenuating element 208 to attenuate the beam portion, adjusting an intensity or strength of the pulses in that portion, and a shutter 210 to control the shape of each pulse of the beam portion. Each beam portion then also passes through an auto-focusing element 212 to focus the beam portion onto a scan head 214. Each scan head 214 includes at least one element capable of adjusting a position of the beam, for example, a galvanometer scanner useful as a directional deflection mechanism. In many embodiments, this is a rotatable mirror able to adjust the position of the beam along a latitudinal direction, orthogonal to the movement vector of the workpiece 104, which can allow for adjustment in the position of the beam relative to the workpiece.

In many embodiments, each scan head 214 includes a pair of rotatable mirrors 216, or at least one element capable of adjusting a position of the laser beam in two dimensions (2D). Each scan head includes at least one drive element 218 operable to receive a control signal to adjust a position of the “spot” of the beam within a scan field and relative to the workpiece. Various spot sizes and scan field sizes can be used. For example, in some embodiments a spot size on the workpiece is on the order of tens of microns within a scan field of approximately 60 mm×60 mm, although various other dimensions and/or combinations of dimensions are possible. While such an approach allows for improved correction of beam positions on the workpiece, it can also allow for the creation of patterns or other non-linear scribe features on the workpiece. Further, the ability to scan the beam in two dimensions means that any pattern can be formed on the workpiece via scribing without having to rotate the workpiece.

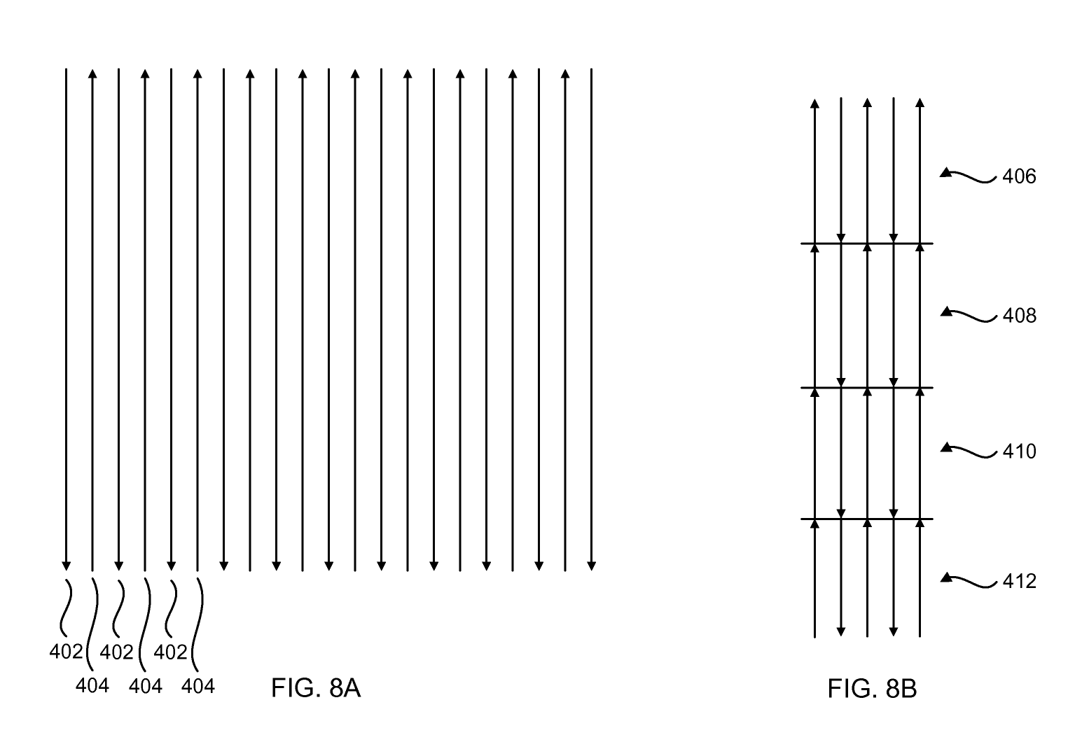

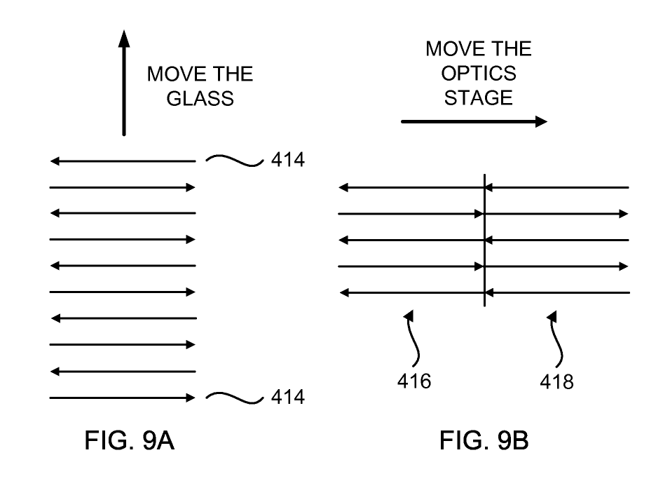

A variety of approaches can be used to laser-scribe lines in different directions using embodiments of the systems and methods disclosed herein. For example, laser-scribe lines having a direction parallel to the movement direction of the workpiece can be formed in a number of ways. FIG. 8A illustrates one such approach, where one or more of the scanners is used to fix the position of one or more of the laser outputs while the workpiece is translated relative to the lasers. Laser-scribe lines 402 can be formed while the glass moves relative to the lasers in a first direction (i.e., from bottom to top in FIG. 8A). The beam position(s) can then be adjusted as the workpiece changes direction. Laser-scribe lines 404 can then be formed while the glass moves relative to the lasers in the opposite direction (i.e., from top to bottom in FIG. 8A). In many embodiments, the glass can move at various rates (e.g., 0 msec to 2 msec or faster). FIG. 8B illustrates another approach for forming scribe lines having a direction parallel to the movement direction of the workpiece, where the scribe lines are formed in separate blocks 406, 408, 410, 412. With this approach, the workpiece can be moved more slowly, which may introduce less position error. The scribe lines can be “stitched” together to create long scribe lines. One or more scanners can be used to scan the laser output over the workpiece at the desired rate (e.g., 0 msec to 2 msec or faster), such that no change to laser parameters are required between the two approaches. A number of approaches can also be used to form scribe lines having a direction perpendicular to the movement direction of the workpiece. In one approach illustrated in FIG. 9A, laser-scribe lines 414 can be formed by using the scanners to scan the output of the lasers while the glass is being slowly moved. In another approach that is illustrated in FIG. 9B, the optics stage can be moved with the workpiece held fixed and the scribe lines can be formed in blocks 416, 418 that can be stitched together to form long lines. In both approaches, one or more scanners can be used to scan the laser output over the workpiece at the desired rate, for example, 2 meters per second, and/or such that no change to laser parameters are required between the two approaches.

Line sensing optics can be used to determine location data for one or more previously formed features. Such location data can be used to control the formation of subsequently formed features relative to previously formed features. For example, data indicative of one or more locations on a previously formed P1 line can be used to control the formation of a P2 line relative to the P1 line. Line sensing optics can include a light source and a camera, which detects the light reflected from the workpiece and/or scribe lines.

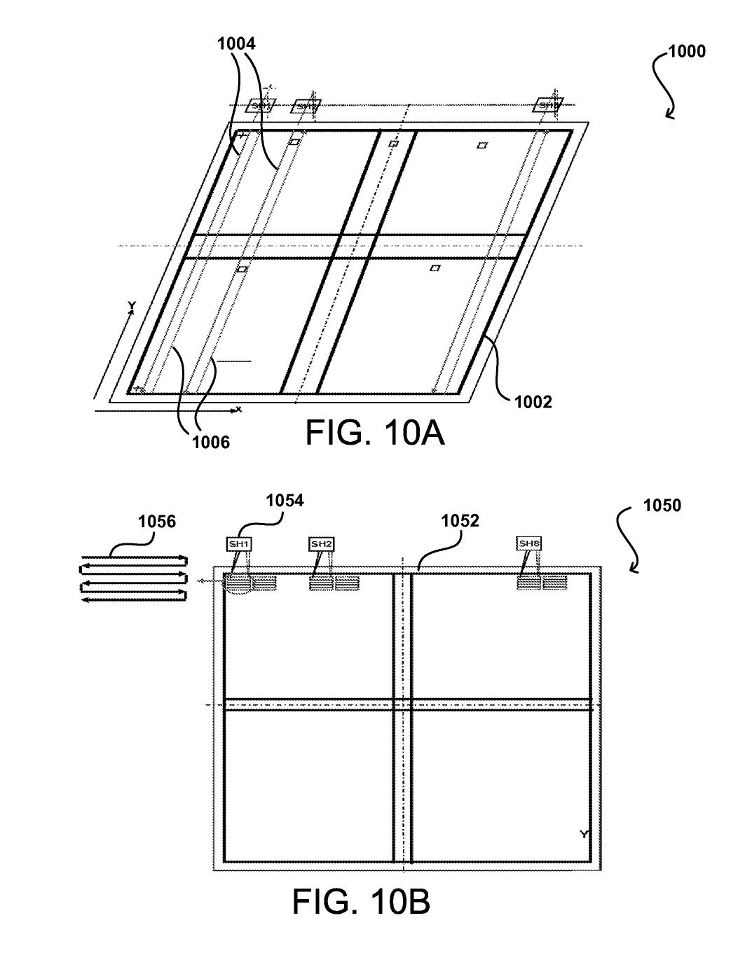

FIG. 10A illustrates an approach 1000 for scanning a series of longitudinal scribe lines on a workpiece 1002. As shown, the substrate is moved continually in a first direction, wherein the scan field for each beam portion forms a scribe line 1004 moving “down” the substrate. In this example, the workpiece is then moved relative to the laser assemblies, such that when the substrate is moved in the opposite direction, each scan field forms a scribe line going “up” the workpiece (directions used for describing the figure only), with the spacing between the “down” and “up” scribes being controlled by the lateral movement of the workpiece relative to the laser assemblies. In this case, the scan heads may not deflect each beam at all. The laser repetition rate can simply be matched to the stage translation speed, with a necessary region of overlap between scribe positions for edge isolation. At the end of a scribing pass, the stage decelerates, stops, and re-accelerates in the opposite direction. In this case, the laser optics are stepped according to the required pitch so that the scribe lines are laid down at the required positions on the glass substrate. If the scan fields overlap, or at least substantially meet within a pitch between successive scribe lines, then the substrate does not need to be moved laterally relative to the laser assemblies, but the beam position can be adjusted laterally between “up” and “down” movements of the workpiece in the laser scribe device. In many embodiments, the laser can scan across the workpiece making a scribe mark at each position of a scribe line within the scan field, such that multiple scribe longitudinal scribe lines can be formed at the same time with only one complete pass of the workpiece being necessary. Many other scribe strategies can be supported as would be apparent to one of ordinary skill in the art in light of the teachings and suggestions contained herein.

FIG. 10B illustrates an approach 1050 for scanning a series of latitudinal (or lateral) scribe lines on a workpiece 1052. As discussed above, each scan head 1054 is able to scan laterally within the scan field of each beam, such that each scan head can create a portion of a scribe line at each position of the workpiece. As shown, each beam can move in one latitudinal direction at one position of the workpiece, then in another latitudinal directions at another position of the workpiece, forming a series of serpentine patterns 1054 as shown in more detail at 1056. As discussed later herein, all latitudinal scribing directions are the same in some embodiments. If the scan fields sufficiently meet, then a full latitudinal scribe line can be formed at each position of the workpiece. If not, the workpiece may need to make several passes in order to form the latitudinal lines, as shown in FIG. 10B.

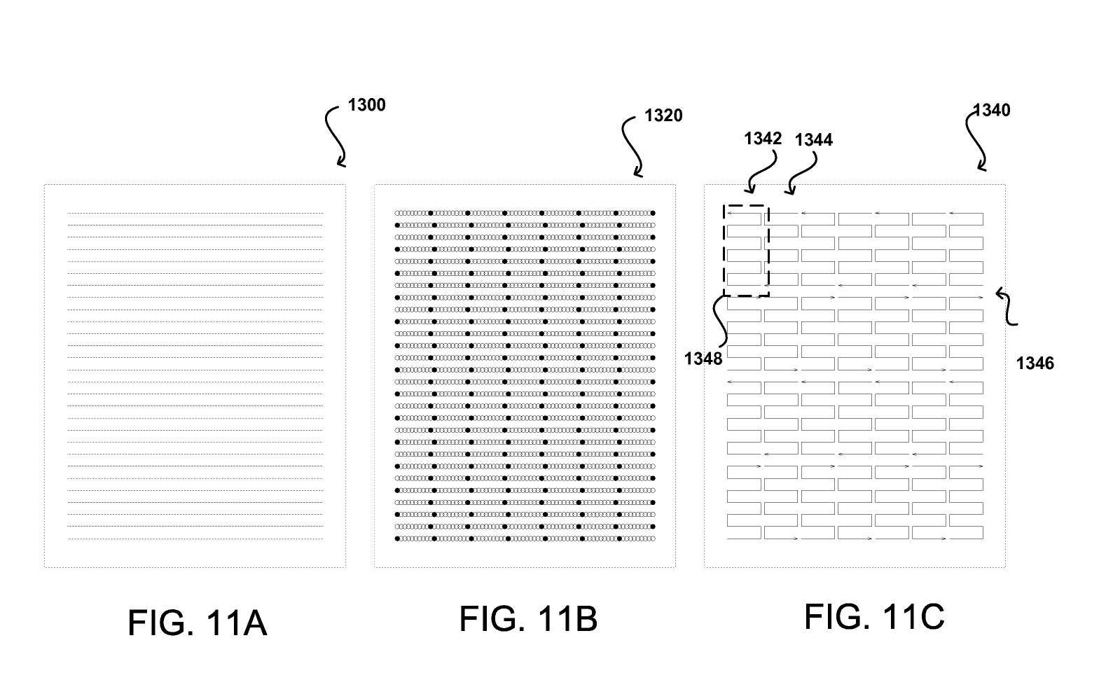

In some embodiments, it is desirable to form portions of multiple lines with a single scanner at a particular longitudinal position of the workpiece. FIG. 11A displays an example of a pattern of parallel scribe lines 1300 to be formed in a layer of the workpiece. Since the workpiece moves longitudinally through the scribing device in this embodiment, the scanner devices must direct each beam laterally so as to form portions or segments of the latitudinal lines within the active area of each scanner device. In the example 1320 of FIG. 11B, it can be seen that each scribe line is actually formed of a series of overlapping scribe “dots,” each being formed by a pulse of the laser directed to a particular position on the workpiece. In order to form continuous lines, these dots must sufficiently overlap, such as by about 25% by area. Portions from each active area must then also overlap in order to prevent gaps. These overlap regions between dots formed by separate active areas can be seen by looking to the black dots in FIG. 11B, which represent the beginning of each scan portion in a serpentine approach. In this example, where there are seven regions shown, if there are seven scanner devices then the pattern can be formed via a single pass of the substrate through the device, as each scanning device can form one of the seven overlapping portions and continuous lines can be thus be formed on a single pass. If, however, there are fewer scanning devices than are necessary to form the number of regions, or the active areas are such that each scanning device is unable to scribe one of these segments, then the substrate may have to make multiple passes through the device. FIG. 11C shows an example 1340 where each scanning device scans according to a pattern at each of a plurality of longitudinal positions of the workpiece. The patterns are used for a latitudinal region along a longitudinal direction, in order to form a segment of each of the scribe lines in a first longitudinal pass of the workpiece through the device. A second segment of each line then is formed using the pattern in an opposite longitudinal pass of the workpiece. The pattern here is a serpentine pattern that allows multiple line segments to be formed by a scanning device for a given longitudinal position of the workpiece. In one example, the patterns of column 1342 can be made by a first scanner as the workpiece travels through the device in a first longitudinal direction. That same scanner can utilize the pattern of column 1344 when the workpiece is then directed back in the opposite longitudinal direction, and so on, in order to form the sequential lines on the workpiece. It should be understood that scribing could occur using the same pattern in the same direction, such as when scribing does not occur when the workpiece moves in the opposite longitudinal direction. Also, certain embodiments may move the workpiece laterally between passes while other embodiments may move the scanners, lasers, optical elements, or other components laterally relative to the workpiece. Such a pattern could be used with one or multiple scanning devices.

In many embodiments, a latitudinal movement occurs for a set of line segments, then the workpiece is moved longitudinally, then another latitudinal movement occurs to form another set, and so on. In many embodiments, the workpiece moves longitudinally at a constant rate, such that the latitudinal movement back and forth requires different scribing patterns between latitudinal passes. These embodiments can result in an alternating of patterns as illustrated by shift position 1346 in FIG. 11C. In this example, all pattern portions above 1346 are scribed during movement in a first latitudinal direction, while the portions directly below 1346 are scribed for the opposite latitudinal direction. The pattern corresponding to area 1348 is scribed by an active area of a single scanner during a substantially continuous latitudinal movement and, depending upon the embodiment, a fixed or substantially continuous longitudinal movement.

Because the scribing for areas such as 1348 occurs during latitudinal motion, however, a pattern must be used that accounts for this motion. If everything was stationary when etching portion 1348 as shown in FIG. 11C, then the substantially rectangular pattern as shown could be used at each position. In certain embodiments, things are moving relatively continually, however, as this minimizes errors due to stopping and starting, etc. When the system is moving laterally, a simple rectangular pattern approach would not result in substantially evenly-spaced and overlapping line portions.

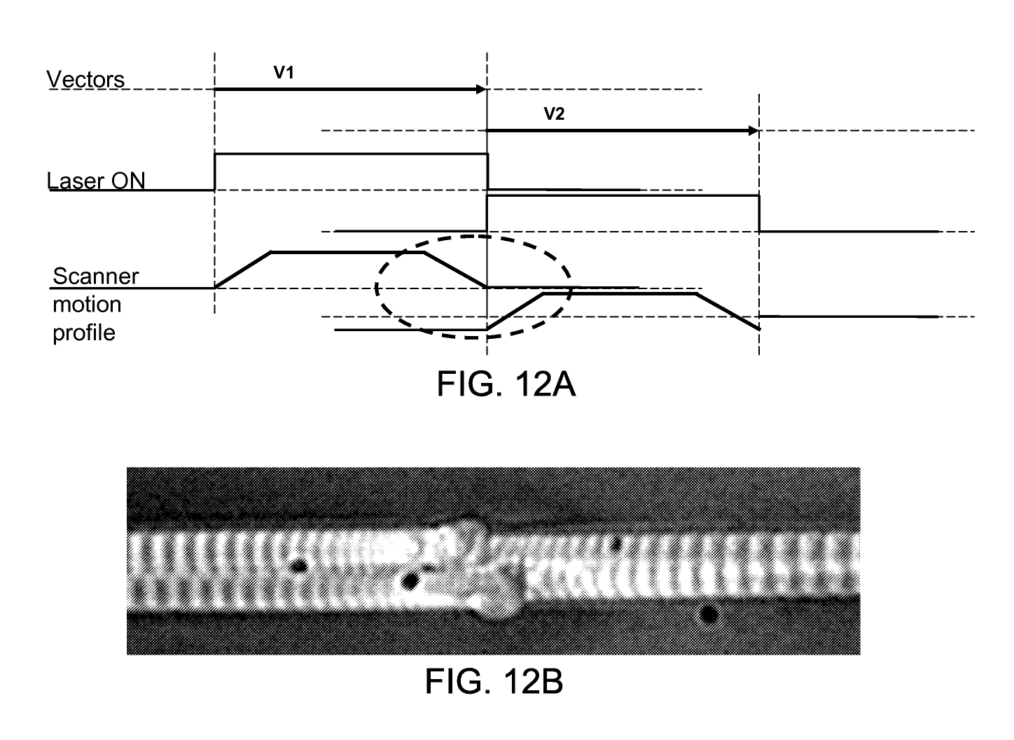

FIG. 12B shows a scribe pattern that can be formed by two lasers, or by separate passes of a single laser. FIG. 12A illustrates a process of scribing wherein the scanner with the first laser slows down and then stops at the end point of the segment, or the position at which the scanner for the second laser beam starts and gains velocity for forming the adjacent segment. This motion profile along with the laser switching should generate a stitch point (seen in FIG. 12B) that may be sometimes undesirable for a number of reasons, such as over or underscribing, etc.

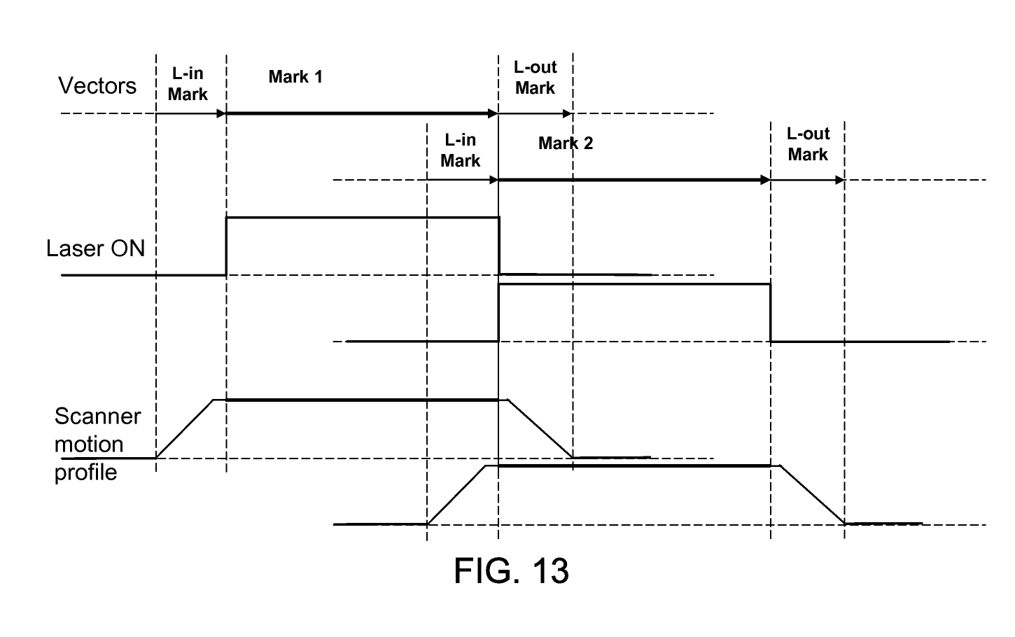

To overcome such problems, an approach in accordance with one embodiment utilizes a relatively constant velocity during that portion of the scan that corresponds to the region to be scribed, such as is illustrated in FIG. 13. By using a “lead-in” and “lead-out” region on either side of a scribe line segment, the scanners can attain desirable velocity before the scribing process begins and maintain that velocity during the entire scribe. The laser can be switched on and off at precise times that correspond to the stitch positions or other segments endpoints. The lead-in & lead-out process shown in FIG. 13 may generate a better stitch, however, such a process may require a significant amount of control mechanism and control code in some embodiments. Additionally, this process can require a greater scan field.

An improvement to the above processes for at least some embodiments is shown in FIG. 14A. The scanners in this process attain desirable velocity before the scribing process begins and maintain velocity during the scribe process as discussed above. In addition, the vectors or scribe segments of this process are selected to overlap, such that both the lasers remain on in the overlap region for the separate segments. This process is shown to generate a better stitch (FIG. 14B). No separate lead-in and lead-out controls and significantly small amount of code (70% smaller compared to the lead-in and lead-out control code) is needed to run the operation. The on-delay and off-delay times of the laser and the velocity of the scanner could be used to calculate and optimize the overlap.

overlap=((laser on-delay)−(laser off-delay))*(scribe-speed)

Even when the lateral positioning of the segments is such that the stitching processes above can result in an improved stitch point, it is possible that there is some longitudinal error or other offset that causes the segments to not stitch together properly. For example, FIG. 15A illustrates a condition where the segments align in the horizontal direction (in the figure) but are offset in the vertical direction, which results in a break in the scribe line and can cause problems with aspects such as electrical isolation.

Accordingly, systems and methods in accordance with various embodiments can utilize any of a number of different approaches to form segments of scribe lines. For example, scribe line patterns can be used that take various shapes or positions, such as may be along a straight line or include various non-linearities to at least one portion of a scribe. FIG. 15 (B-C) shows some exemplary scribe patterns and exemplary stitching processes that can be used in accordance with various embodiments. Collinear scribes can be stitched as shown in FIG. 15B, as discussed above, but can be susceptible to small offset errors.

In another embodiment, the stitch points can be selected at locations on the workpiece that coincide with other isolation or scribe lines. For example, FIG. 15C illustrates an example wherein the stitch point is selected to substantially coincide with the position of a longitudinal isolation line. As can be seen, even in the presence of an offset between the two latitudinal scribe segments, there will be no electrical gap between the segments as the isolation line (e.g., “long line”) functions to electrically join the segments. In some embodiments the line segments can be substantially straight but overlap near an existing line as discussed while in other embodiments the segments can be shaped as appropriate.

It is understood that the examples and embodiments described herein are for illustrative purposes, and that various modifications or changes in light thereof will be suggested to a person skilled in the art and are to be included within the spirit and purview of this application and the scope of the appended claims. Numerous different combinations are possible, and such combinations are considered to be part of the present invention.

What is claimed is:

1. A system for creating an improved stitch while scribing a workpiece, comprising:
at least one laser operable to generate output able to remove material from at least a portion of the workpiece; and
at least one scanner operable to direct output from the at least one laser to form first and second scribe segments;
wherein at least one of a velocity of the scanner, a switching of the laser, and a patterning of the scribe segments is selected such that the first scribe at least partially overlaps with the second scribe on the workpiece.

2. The system of claim 1, wherein the first and second scribe segments are formed by separate lasers and scanners.

3. The system of claim 1, further comprising
a translation stage operable to support the workpiece and move the workpiece along a longitudinal translation vector with respect to the scanning device, the translation stage including at least one stationary section and a lateral translation section; and
a lateral translation mechanism operable to laterally translate the scanning device.

4. The system of claim 2, wherein the scanning device is operable to control a position of the output from the laser in two dimensions.

5. The system of claim 2, further comprising additional scanning devices operable to control positions of the outputs from the additional lasers.

6. The system of claim 1, wherein the first scribe on the workpiece is collinear with the second scribe.

7. The system of claim 1, wherein at least a portion of at least one of the first and second scribes on the workpiece has a non-linearity.

8. The system of claim 1, further comprising additional lasers operable to generate output able to concurrently remove material from additional portions of the workpiece.

9. The system of claim 1, wherein the workpiece comprises a substrate and at least one layer used for forming a solar cell, and wherein the laser is able to remove material from the at least one layer.

10. The system of claim 1, further comprising a beam profiling device for measuring a position or an attribute of the output from the laser.

11. The system of claim 1, further comprising a substrate thickness sensor for determining a thickness of the workpiece, and wherein a focus point of the laser is able to be adjusted in response to the determined thickness.

12. The system of claim 1, further comprising an exhaust mechanism for extracting material ablated or otherwise removed from the workpiece during the scribing process.

13. The system of claim 1, further comprising a power meter for measuring the laser power incident on the workpiece.

14. The system of claim 1, wherein the scanner is controlled such that scribing is performed at substantially constant velocity.

15. A method of creating an improved stitch while scribing a workpiece, comprising:
generating a first scribe on the workpiece;
generating a second scribe on the workpiece; and
controlling at least one of a velocity of at least one scanner used to direct at least one laser beam to form the first and second scribes, a switching of at least one laser used to form the first and second scribes, and patterning of the scribe segments such that the first scribe at least partially overlaps with the second scribe on the workpiece.

16. The method of claim 15, further comprising controlling a position of the output from the first laser by a scanning device operable to control the position of the output from the first laser.

17. The method of claim 16, wherein the scanning device is operable to control the position of the output from the laser in two dimensions.

18. The method of claim 16, further comprising controlling positions of the outputs from additional lasers by additional scanning devices operable to control the position of the output from the additional lasers.

19. The method of claim 15, wherein the first scribe on the workpiece is collinear with the second scribe.

20. The method of claim 15, wherein the first scribe on the workpiece is not collinear with the second scribe.

21. The method of claim 16, wherein at least a portion of at least one of the first and second scribes on the workpiece has a non-linearity.

22. The method of claim 15, further comprising removing material from additional portions of the workpiece by concurrently using additional lasers.

23. The method of claim 15, wherein the scribing is performed at constant velocity.

24. A system for creating an improved stitch while scribing a workpiece, comprising:
at least one laser operable to generate output able to remove material from at least a portion of the workpiece; and
at least one scanner operable to direct output from the at least one laser to form first and second scribe segments;
wherein a stitch point of the first and second scribe segments is selected to substantially correspond to a position of a third scribe segment, such that the third scribe segment will function to connect the first and second scribe segments upon an offset of the first and second scribe segments on the workpiece.

25. A method of creating an improved stitch while scribing a workpiece, comprising:
generating a first scribe on the workpiece;
generating a second scribe on the workpiece; and
selecting a stitch point of the first and second scribe segments to substantially correspond to a position of a third scribe segment, such that the third scribe segment will function to connect the first and second scribe segments upon an offset of the first and second scribe segments on the workpiece.
